(19) United States
(12) Patent Application Publication
(10) Pub. No.: US 2006/0145954 A1
(43) Pub. Date: Jul. 6, 2006

(54) Power recovery circuit, plasma display, module for plasma display

(76) Inventors: Yutaka Kubota, Gunma (JP); Norio Okazaki, Tochigi (JP); Kazumasa Arai, Gunma (JP)

Correspondence Address: FISH & RICHARDSON P.C.;Citigroup Center, 52nd Floor, 153 East 53rd Street, New York, NY, 10022-4611, US

(21) Appl. No.: 11/305,501

(22) Filed: Dec. 15, 2005

(30) Foreign Application Priority Data
Dec. 17, 2004 (JP) 2004-365614

(51) Int. Cl. G09G 3/28

(52) U.S. Cl. 345/66

(57) ABSTRACT

A power recovery circuit includes a capacitor (C2) for accumulating power recovered from a panel (C1), a third switching element (Q3) for discharging the capacitor (C2), a fourth switching element (Q4) for charging the capacitor (C2), and a level shift unit for shifting a control signal for controlling Q4 to the voltage level of the capacitor (C2). The threshold voltage of Q4 is set higher than that of Q3. Accordingly, Q4 can be prevented from malfunctioning due to a decrease in the voltage of the capacitor (C2).

Priority is claimed to Japanese Patent Application Number JP2004-365614 filed on Dec. 17, 2004, the disclosure of which is incorporated herein by reference in its entirety.

### BACKGROUND OF THE INVENTION

1. Field of the Invention

The present invention relates to a power recovery circuit, a plasma display, and a module for a plasma display. In particular, the present invention relates to a power recovery circuit, a plasma display, and a module for a plasma display which prevent a malfunction of a switching element partially constituting the power recovery circuit.

2. Description of the Related Art

Plasma display panels (hereinafter abbreviated to PDPs) have thin structures, are flicker free, and have large display contrast ratios. Further, the PDPs can be configured to have relatively large screens. Also, the PDPs have high response speeds and are of selfluminous types. The PDPs can also be configured to perform multicolor light emission by using phosphors. Accordingly, in recent years, the PDPs are becoming widely used in the fields of computer-related display devices, color image displays, and the like.

A PDP requires a drive circuit for supplying a voltage to a panel which is a capacitive load. Further, apower recovery circuit for recovering power from the panel is also used. This technology is described for instance in Japanese Examined Patent Application Publication No. Hei 07-109542.

FIG. 7 illustrates examples of a drive circuit 100 for driving a PDP and a recovery circuit 101. In the drive circuit 100, a first switching element Q1 and a second switching element Q2 perform switching based on control signals from a control IC IC1. In the description below, the first and second switching elements Q1 and Q2 are occasionally simply referred to as Q1 and Q2, respectively. The switching elements Q1 and Q2 are connected in series, and the connection point between Q1 and Q2 is connected to a panel C1. The drain electrode of Q1 is connected to a power supply Vcc, and the source electrode of Q2 is grounded. The panel C1 is charged or discharged by Q1 and Q2 performing switching.

The recovery circuit 101 includes a coil L, a capacitor C2, a third switching element Q3, a fourth switching element Q4, a control IC IC2, and a level shift unit 103. In the description below, the third and fourth switching elements Q3 and Q4 are occasionally simply referred to as Q3 and Q4, respectively. The coil L and the capacitor C2 are connected in series. The capacitor C2 is charged with part of electric charges accumulated in the panel C1. In the case where the voltage of the power supply Vcc is 180 V, the capacitor C2 is charged to a voltage of 90 V.

The third and fourth switching elements Q3 and Q4 are connected in series, and the coil L is connected to the connection point therebetween. Further, the drain electrode of Q3 and the source electrode of Q4 are connected to the capacitor C2.

The level shift unit 103 is a circuit which level-shifts a control signal generated in IC2 to a control signal referred to the voltage of the source electrode of Q4. Here, the source electrode of Q4 is connected to the capacitor C2 which is charged to approximately 90 V. Accordingly, the control signal from IC2 is level-shifted to a control signal referred to 90 V, and is supplied to the gate electrode of the fourth switching element Q4.

The operation of the drive circuit and the recovery circuit configured as described above will be described with reference to FIGS. 8A and 8B. FIG. 8A is a circuit diagram illustrating the operation of the circuits, and FIG. 8B is a graph illustrating a change in the voltage Vp of the panel C1 with time.

A sustain discharge operation of the drive circuit of the PDP will be described with reference to FIGS. 8A and 8B. Here, the operation of causing a sustain discharge will be described in such a manner that states 1 to 4 are separated. Further, in FIG. 8A, the flows of currents in the respective states are indicated by paths denoted by numbers (1) to (4).

In state 1, the panel C1 is charged with electric charges accumulated in the capacitor C2. Specifically, the third switching element Q3 is turned on to form a resonant circuit including the panel C1 and the coil L, thus charging the panel C1. This operation raises the voltage of the panel C1 to, for example, a voltage near 180 V.

In state 2, the first switching element Q1 is turned on, whereby the voltage Vp of the panel C1 is clamped to a power supply voltage Vcc (e.g., 180 V). In this state, a discharge current flows into pixels of the PDP to emit light.

In state 3, electric charges accumulated in the panel C1 is recovered to be stored in the capacitor C2. Specifically, the fourth switching element Q4 is turned on, whereby the resonant circuit including the panel C1 and the coil L is formed again and the capacitor C2 is charged. As a result, the voltage of the capacitor C2 becomes approximately 90 V, which is half the voltage of the panel C1. At this time, the voltage Vp of the panel C1 drops to ground level.

In state 4, the second switching element Q2 is turned on, whereby the voltage Vp of the panel C1 is clamped to ground level.

A display in the PDP is performed by repeating the above-described sustain discharge operation. Further, the above-described circuit has the advantage of power saving because electric charges accumulated in the panel C1 are recovered and recycled.

However, in the drive circuit and the recovery circuit of the above-described plasma display, there is the risk that switching elements partially constituting these circuits may malfunction.

Specifically, referring to FIG. 8A, when the capacitor C2 is discharged by turning on Q3 in state 1, the voltage of the capacitor C2 slightly drops. The value of this voltage drop is approximately 4 V to 5 V. Further, the capacitor C2 is connected to the source electrode of Q4. Accordingly, with the voltage drop across the capacitor C2, the potential of the source electrode of Q4 also drops. Meanwhile, the gate voltage of Q4 is maintained constant by the effects of a capacitor C3 and a diode D1. Thus, the voltage between the source and gate of Q4 increases due to the voltage drop across the capacitor C2.

In the case where the threshold voltage of Q4 is as low as approximately 4 V, the above-described increases in the voltage between the source and gate turns on Q4 in state 1, thus causing a malfunction. There is also the risk that the temperature of Q4 may be excessively raised by this malfunction and that Q4 may therefore be broken.

### SUMMARY OF THE INVENTION

The present invention has been accomplished in view of the above-described problems. The present invention provides a power recovery circuit and a plasma display which prevent a malfunction of a switching element.

According to the present invention, a power recovery circuit for recovering power from a capacitive load driven by a drive circuit includes a capacitor for accumulating power recovered from the capacitive load, a first switching element for discharging the capacitor, a second switching element for charging the capacitor, and a level shift unit for shifting a control signal for controlling the second switching element to a voltage level of the capacitor. The second switching element maintains an OFF operation even if a voltage of the capacitor decreases due to the turning on of the first switching element.

Here, for example, referring to FIG. 4A, the first switching element is Q3 and the second switching element is Q4.

Further, according to the present invention, a plasma display includes a drive circuit for driving a capacitive load, and a power recovery circuit for recovering power from the capacitive load. The drive circuit includes a first switching element for charging the capacitive load and a second switching element for discharging the capacitive load. The power recovery circuit includes a capacitor for accumulating power recovered from the capacitive load, a third switching element for discharging the capacitor, a fourth switching element for charging the capacitor, and a level shift unit for shifting a control signal for controlling the fourth switching element to a voltage level of the capacitor. The fourth switching element maintains an OFF operation even if a voltage of the capacitor decreases due to the turning on of the third switching element. Here, referring to FIG. 4A, the first switching element is Q1, the second switching element is Q2, the third switching element is Q3, and the fourth switching element is Q4.

Moreover, according to the present invention, a module f or a plasma display includes a hybrid integrated circuit device fixed to a surface of a mount board, and has a power recovery circuit incorporated therein. The power recovery circuit recovers power from a capacitive load driven by a drive circuit.

The power recovery circuit includes a capacitor for accumulating power recovered from the capacitive load, a first switching element for discharging the capacitor, a second switching element for charging the capacitor, and a level shift unit for shifting a control signal for controlling the second switching element to a voltage level of the capacitor. The second switching element maintains an OFF operation even if a voltage of the capacitor decreases due to the turning on of the first switching element. The first and second switching elements are incorporated in the hybrid integrated circuit device. The capacitor is fixed directly to the mount board.

The first and second switching elements are connected to the capacitor through conducting paths formed on the surface of the mount board.

Here, for example, referring to FIG. 4A, the first switching element is Q3 and the second switching element is Q4.

### BRIEF DESCRIPTION OF THE DRAWINGS

FIG. 1 is a diagram illustrating a display panel of a plasma display of an embodiment of the present invention.

FIG. 2 is a diagram illustrating an electrical configuration of the plasma display of the embodiment of the present invention.

FIG. 3 is a circuit diagram illustrating the configurations of a drive circuit and a power recovery circuit of the embodiment of the present invention.

FIGS. 4A to 4H are views for explaining the drive circuit and the power recovery circuit of the embodiment of the present invention. FIG. 4A is a circuit diagram, and FIGS. 4B to 4H are waveform diagrams.

FIG. 5 is a graph illustrating characteristics of switching elements partially constituting the drive circuit and the power recovery circuit of the embodiment of the present invention.

FIGS. 6A and 6B are cross-sectional views illustrating a circuit module in which the drive circuit and the power recovery circuit of the embodiment of the present invention are incorporated.

FIG. 7 is a circuit diagram illustrating the configurations of a conventional drive circuit and a conventional power recovery circuit.

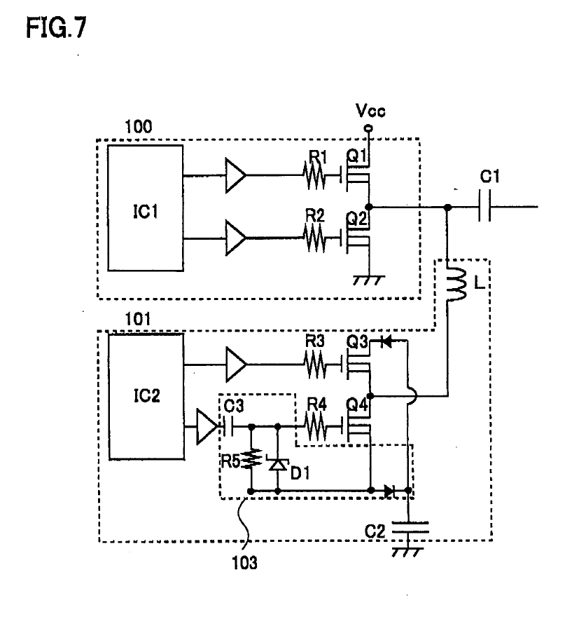

FIGS. 8A and 8B are views for explaining the operation of the conventional drive circuit and the conventional power recovery circuit. FIG. 8A is a circuit diagram and FIG. 8B is a waveform diagram.

### DESCRIPTION OF THE PREFERRED EMBODIMENTS

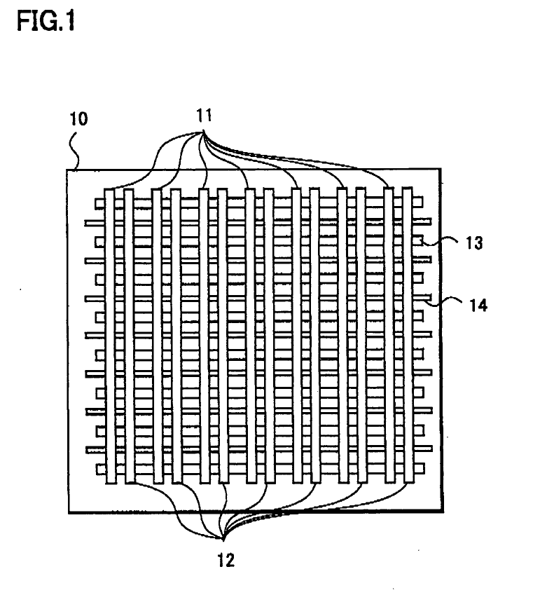

FIG. 1 is a plan view illustrating the schematic of a plasma display panel 10. In the display panel 10, X electrodes 11 and Y electrodes 12 arranged in parallel are formed, and address electrodes 14 are formed to be perpendicular to the X and Y electrodes 11 and 12. The X and Y electrodes 11 and 12 are electrodes which mainly cause sustain discharges for producing a luminous display. Sustain discharges are performed by repeatedly applying voltage pulses between the X and Y electrodes 11 and 12. Meanwhile, the address electrodes 14 are electrodes for selecting discharge cells to be caused to emit light. Voltages used to cause write discharges for selecting discharge cells are applied between the Y and address electrodes 12 and 14. Partitions 13 for partitioning discharge cells are formed between the address electrodes 14.

A discharge of the plasma display can take on just two values, ON and OFF states. Accordingly, brightness is expressed by the number of times of light emission. That is, the number of times of light emission is adjusted according to a required luminance of a cell.

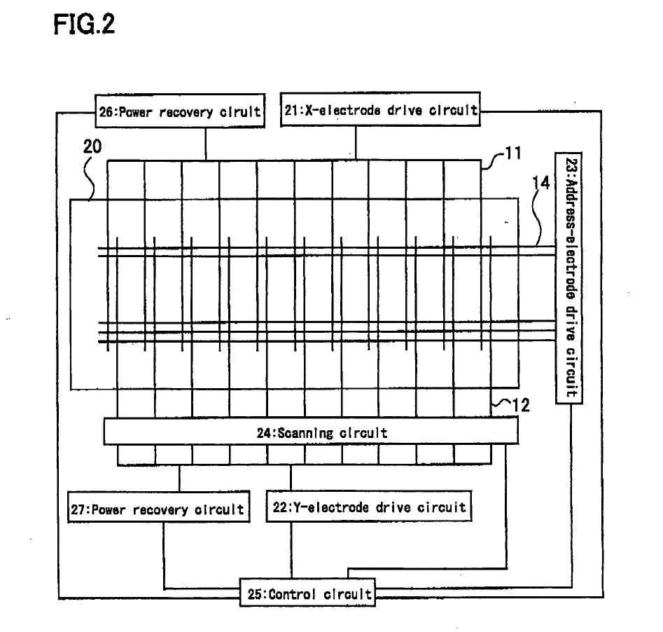

FIG. 2 is a diagram illustrating an electrical configuration of a plasma display device. The plasma display device illustrated in this drawing includes a display 20, an X-electrode drive circuit 21, a Y-electrode drive circuit 22, an address-electrode drive circuit 23, a scanning circuit 24, and a control circuit 25. Further, power recovery circuits 26 and 27 are connected to the X and Y electrodes 11 and 12, respectively.

The control circuit 25 is supplied with various kinds of signals including a synchronization signal, a clock signal, and an RGB signal from the outside. Based on these various kinds of signals, the control circuit 25 controls each drive circuit, whereby display data is displayed on the display 20. The scanning circuit 24 scans the Y electrodes 12 and the address-electrode drive circuit 23 drives the address electrodes 14, thus causing write discharges for writing data to the display 20. Further, in cells having data written thereto, sustain discharges are performed by the X- and Y-electrode drive circuits 21 and 22. Moreover, the power recovery circuits 26 and 27 have the function of recovering and recycling electric charges accumulated between the electrodes.

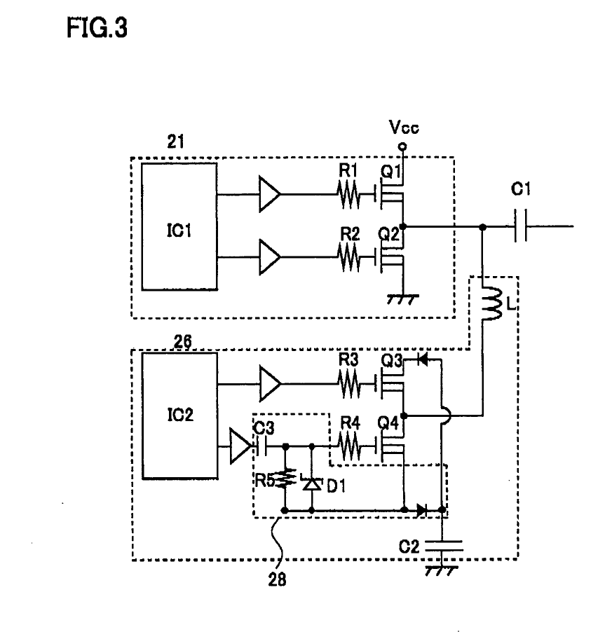

The above is an overview of the plasma display. Next, the electrode drive circuits and the power recovery circuits will be described in detail with reference to FIG. 3 and subsequent drawings.

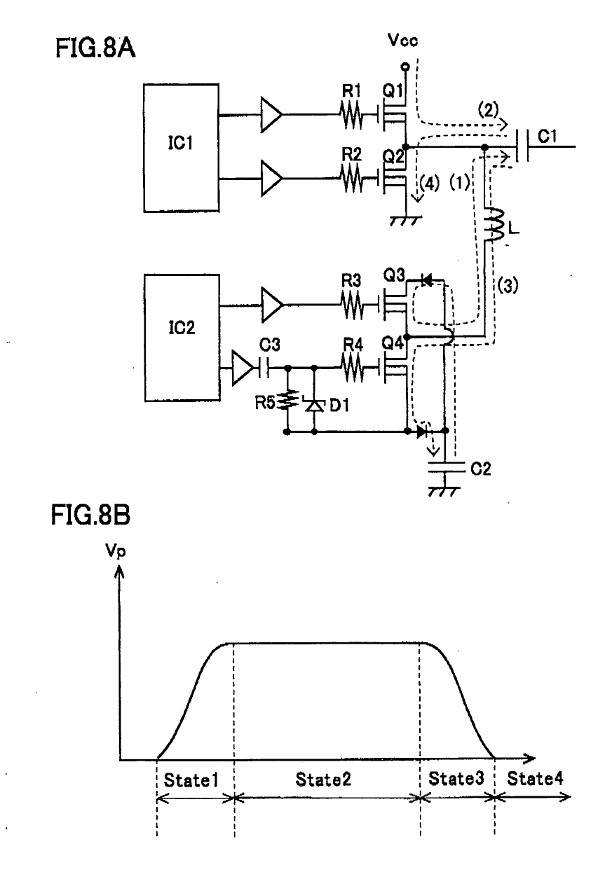

FIG. 3 is a circuit diagram illustrating the configurations of the X-electrode drive circuit 21 (or Y-electrode drive circuit 22) and the power recovery circuit 26 of the embodiment of the present invention. The same components as those of FIG. 8 are denoted by the same reference numerals.

The X-electrode drive circuit 21 includes a first switching element Q1 and a second switching element Q2 connected in series, and IC1 which controls these switching elements. In the description below, the first and second switching elements Q1 and Q2 are occasionally simply referred to as Q1 and Q2, respectively. A panel C1, which is a capacitive load, is connected to the connection point between Q1 and Q2. The drain electrode of Q1 is connected to a power supply Vcc, and the source electrode of Q2 is grounded.

The switching elements Q1 and Q2 are metal-oxide-semiconductor field effect transistors (MOSFETs) or insulated-gate bipolar transistors (IGBTs). An amplifier circuit is provided between Q1 and IC1. This amplifier circuit amplifies, for example, a control signal of approximately 4 V to approximately 15 V. Such amplification of a control signal makes it possible for Q1 to perform switching quickly. Further, a resistor R1 is provided between Q1 and IC1. This resistor stabilizes the operation of Q1. The configurations of the amplifier circuit and the resistor are the same for other switching elements.

The power recovery circuit 26 includes a third switching element Q3 and a fourth switching element Q4 connected in series. In the description below, the third and fourth switching elements Q3 and Q4 are occasionally referred to as Q3 and Q4, respectively. The drain electrode of Q3 and the source electrode of Q4 are connected to a capacitor C2. Further, the connection point between Q3 and Q4 is connected to the panel C1 through a coil L. Moreover, the power recovery circuit 26 includes a level shift unit 28 for shifting the level of the gate potential of Q4.

The capacitor C2 is intended to accumulate electric charges discharged from the panel C1 and has a large capacitance. Specifically, in the case of a plasma display panel of approximately 42 inches to 50 inches, the capacitance of the capacitor C2 becomes approximately 8 μF to 16 μF.

The coil L, together with the panel C1, constitutes a series resonant circuit. Thus, the capacitor C2 is charged to half the voltage of the panel C1. For example, in the case where the panel C1 is charged to a voltage of 180 V, the capacitor C2 is charged to a voltage of 90 V.

The level shift unit 28 includes a resistor R5 and a Zener diode D1 connected in parallel in paths between the source and gate electrodes of Q4, and a capacitor C3 provided between the gate electrode of Q4 and IC2. By the provision of the level shift unit 28, the level of a control signal generated by IC2 is shifted to a voltage referred to the voltage of the capacitor C2. For example, a control signal making transitions between 0 V to 15 V is level-shifted to a signal making transitions between 90 V to 105 V.

Further, diodes are connected to the drain electrode of Q3 and the source electrode of Q4, respectively. This makes it possible to prevent Q3 and Q4 from being reverse biased.

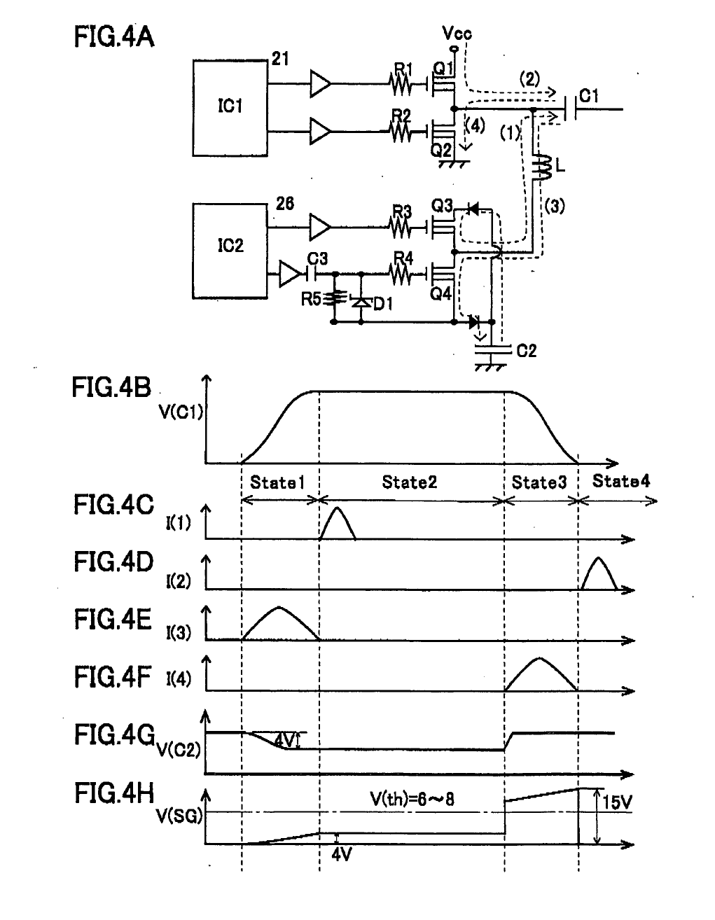

Next, the operation of the above-described circuit will be described with reference to FIGS. 4A to 4H. FIG. 4A is a circuit diagram of the X-electrode drive circuit 21 and the power recovery circuit 26. FIG. 4B is a waveform diagram of a voltage to which the panel C1 is charged. FIGS. 4C to 4F are waveform diagrams illustrating the values of currents flowing through the switching elements Q1, Q2, Q3, and Q4. FIG. 4G is a waveform diagram illustrating the voltage of the capacitor C2. FIG. 4H is a waveform diagram illustrating the voltage between the source and gate of Q4.

The operation of the circuit illustrated in FIG. 4A will be described. Here, the operation of sustaining discharges in the panel C1 will be described in such a manner that states 1 to 4 are separated. In FIG. 4A, the flows of currents in the respective states are indicated by paths denoted by numbers (1) to (4).

In state 1, the panel C1 is charged with electric charges accumulated in the capacitor C2. Specifically, in this state, the capacitor C2 is charged to a voltage of, for example, approximately 90 V by the preceding operation of sustain discharges. In this state, the third switching element Q3 is turned on, whereby the panel C1 is charged through the resonant circuit including the panel C1 and the coil L. This operation raises the voltage of the panel C1 to, for example, a voltage near 180 V. The flow of a current passing through Q3 has the waveform illustrated in FIG. 4E. Further, in this state, Q3 is in an ON state; meanwhile, Q1, Q2, and Q4 are in OFF states.

In state 2, the first switching element Q1 is turned on, whereby the voltage Vp of the panel C1 is clamped to a power supply voltage Vcc (e.g., 180 V). In this state, a discharge current path to pixels of the PDP is formed. A current passing through Q1 has the waveform illustrated in FIG. 4C. In this state, Q1 is in an ON state; meanwhile, Q2, Q3, and Q4 are in Off states.

In state 3, electric charges accumulated in the panel C1 is recovered to be stored in the capacitor C2. Specifically, the fourth switching element Q4 is turned on, whereby the resonant circuit including the panel C1 and the coil L is formed again and the capacitor C2 is charged. As a result, the voltage of the capacitor C2 becomes approximately 90 V, which is half the voltage of the panel C1. At this time, the voltage Vp of the panel C1 drops to ground level. In this state, a current passing through Q4 has the waveform illustrated in FIG. 4F. Further, in this state, Q4 is in an ON state; meanwhile, Q1, Q2, and Q3 are in OFF states.

In state 4, the second switching element Q2 is turned on, whereby the voltage Vp of the panel C1 is clamped to ground level. Connected to the opposite side of the panel C1 is the Y-electrode drive circuit 22. In the case where there is an ON pixel in the panel C1, a discharge current flows. In this state, a current passing through Q2 has the waveform illustrated in FIG. 4D. Further, in this state, Q2 is in an ON state; meanwhile, Q1, Q3, and Q4 are in OFF states.

In the embodiment of the present invention, Q4 is prevented from malfunctioning by setting the threshold voltage of Q4, which is a MOSFET or an IGBT, to be high. This point will be described with reference to FIGS. 4A, 4G, and 4H. FIG. 4G is a waveform diagram illustrating the voltage of the capacitor C2, and FIG. 4H is a waveform diagram illustrating the voltage between the gate and source of Q4.

Referring to FIG. 4G, in state 1, when electric charges accumulated in the capacitor C2 are supplied to the panel C1 by turning on Q3, the voltage of the capacitor C2 slightly decreases. Specifically, the voltage of the capacitor C2 decreases by approximately 4 V to become approximately 86 V. Further, since the capacitor C2 is connected to the source electrode of Q4, the voltage of the source electrode of Q4 also decreases by approximately 4 V.

On the other hand, the gate electrode of Q4 is maintained at approximately 90 V by the effects of the capacitor C3 and the diode D1 during an OFF operation. Thus, the voltage between the gate and source of Q4 rises by approximately 4 V with a decrease in the voltage of the capacitor C2. Accordingly, if the threshold voltage of Q4 is not more than approximately 4 V, a malfunction occurs in which Q4 is turned on in state 1. This malfunction causes problems such as overheating of Q4.

Referring to FIG. 4H, in this embodiment, the above-described malfunction is prevented by setting the threshold voltage of Q4 higher than those of the other switching elements. For example, a malfunction due to a decrease in the voltage of the capacitor C2 is prevented by setting the threshold voltage of Q4 at approximately 6 V to 8 V. That is, Q4 maintains the OFF operation. This is because the threshold voltage of Q4 is larger than the value of the voltage drop across C2. Further, setting the threshold voltage of Q4 high results in the necessity for a higher driving voltage. However, since a high-voltage control signal of approximately 15 V is used in this embodiment, Q4 can be turned on without problems.

Moreover, as for Q1, Q2, and Q3, switching elements having thresholds of approximately 4 V may be used as they are. Since the source electrode of each of these switching elements is not connected to the capacitor C2, there are no fluctuations in the voltage between the gate and source thereof which are associated with a decrease in the voltage of C2. Further, the adoption of switching elements having as low thresholds as possible has the advantage that currents flowing through the switching elements are made easy to flow.

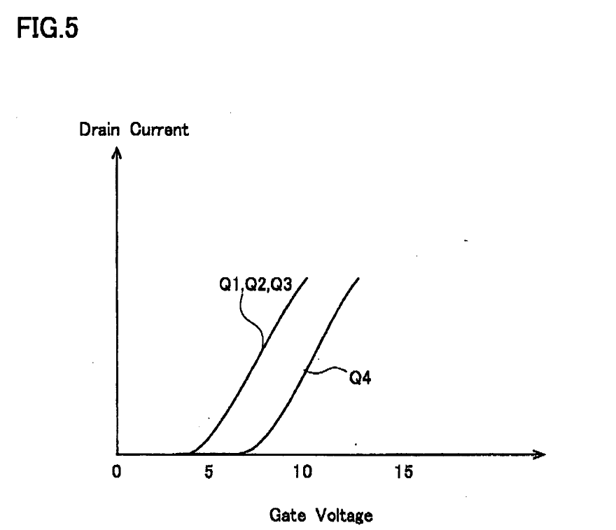

Next, characteristics of the above-described switching elements will be described with reference to the graph of FIG. 5. In this graph, the horizontal axis indicates a voltage applied to a gate and the vertical axis indicates the value of a current flowing through a drain electrode. Here, characteristics were measured by changing the gate voltage with the voltage applied to the drain electrode maintained constant.

In each of Q1, Q2, and Q3, the drain current increases at the time that the gate voltage exceeds 4 V, which is the threshold voltage.

In Q4, since the threshold voltage thereof is set higher than those of the other switching elements, the drain current starts to increase at the time that the gate voltage becomes approximately 7 V. Accordingly, even if a decrease in the source voltage causes the voltage between the gate and source to increase to approximately 4 V, Q4 is not turned on and does not malfunction.

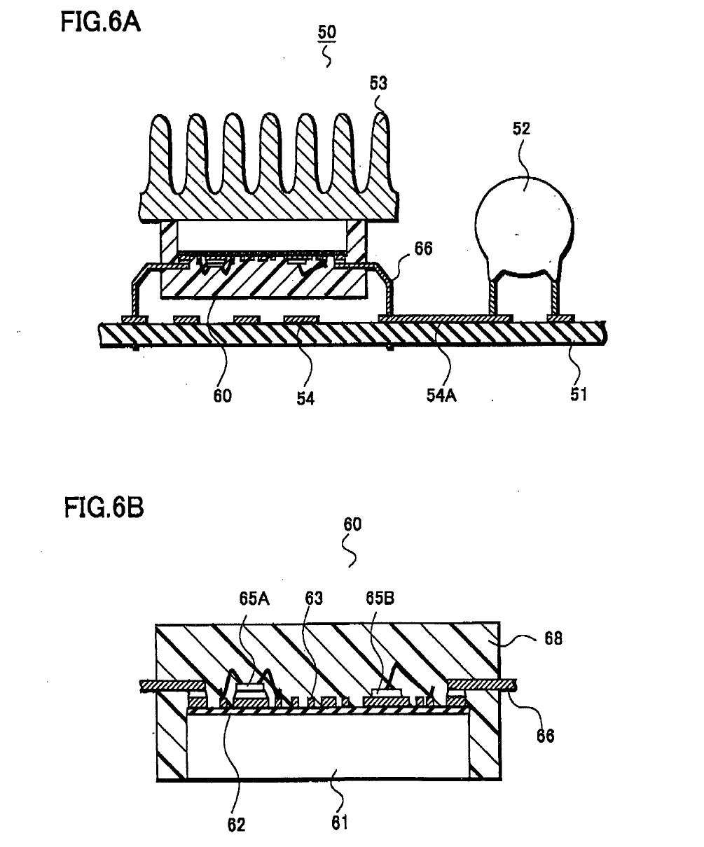

The configuration of a circuit module 50 into which the above-described drive circuit is incorporated will be described with reference to FIGS. 6A and 6B. FIG. 6A is a cross-sectional view of the circuit module 50, and FIG. 6B is a cross-sectional view of a hybrid integrated circuit device 60 partially constituting the circuit module 50.

Referring to FIG. 6A, the circuit module 50 has a configuration including a mount board 51, conducting paths 54 formed on a surface of the mount board 51, and the hybrid integrated circuit device 60 and capacitors 52 which are connected to the conducting paths 54. Further, a coil is also mounted on the mount board 51. Here, the hybrid integrated circuit device 60 is mounted by inserting leads 66 into the mount board 51. Moreover, the capacitors 52 are mounted by inserting terminals extended to the outside into the mount board 51.

To the upper surface of the hybrid integrated circuit device 60, a radiating fin 53 is fixed which is made of metal such as aluminum. Accordingly, the heat generated in an element incorporated in the hybrid integrated circuit device 60 is favorably radiated to the outside through the radiating fin 53. Specifically, an element which switches a high voltage and a large current at a high frequency of approximately 200 kHz is incorporated in the hybrid integrated circuit device 60. Since a large amount of heat is generated in such an element, heat radiation properties of the hybrid integrated circuit device 60 are important.

The capacitors 52 have the function of accumulating electric charges recovered from a monitor of a plasma display, and are relatively large. Specifically, the capacitors 52 are large elements having heights of approximately 12 mm. On the other hand, the thickness of the hybrid integrated circuit device 60 is approximately 4 mm. Accordingly, it is difficult to incorporate the capacitors 52 in the hybrid integrated circuit device 60. Thus, the capacitors 52 are singly mounted on the mount board 51. Here, for example, eight capacitors 52 each having a capacitance of 1 μF are mounted in parallel.

The capacitors 52 and the hybrid integrated circuit device 60 are connected through a conducting path 54A formed on the surface of the mount board 51. Electric signals exchanged between the hybrid integrated circuit device 60 and the capacitors 52 are at high frequencies and high voltages. Accordingly, if a path in the conducting path 54A becomes long, the impedance and inductance associated with the conducting path 54A increase. Thus, the waveforms of electric signals may deteriorate. Further, noise may occur in the waveforms. Accordingly, in this embodiment, the adverse effect of the impedance is reduced by placing the hybrid integrated circuit device 60 and the capacitors 52 as close as possible to each other.

Further, the radiating fin 53 mounted on a top portion of the hybrid integrated circuit device 60 is heated to a high temperature. Accordingly, if the capacitors 52 and the hybrid integrated circuit device 60 are placed extremely close to each other, the capacitors 52 may be heated by the heat radiated from the radiating fin 53. Thus, in this embodiment, the distance by which the hybrid integrated circuit device 60 and the capacitors 52 are separated is set to approximately 1 cm to 0.5 cm.

The configuration of the hybrid integrated circuit device 60 will be described with reference to the cross-sectional view of FIG. 6B. In the hybrid integrated circuit device 60, a conducting pattern 63 is formed on a surface of a circuit substrate 61 made of metal such as aluminum with an insulating layer 62 interposed therebetween.

To the conducting pattern 63, switching elements 65B and an IC 65A are electrically connected. The switching elements 65B are switching elements partially constituting the X-electrode drive circuit 21, the power recovery circuit 26, or the like illustrated in FIG. 4A. Further, the IC 65A is an element which controls these switching elements. The switching elements 65B which operate at high frequencies to generate a large amount of heat may be fixed to the conducting pattern 63 with a heat sink interposed therebetween. Alternatively, if heat radiation through the circuit substrate 61 is sufficient, the switching elements 65B may be fixed directly to the conducting pattern 63.

Sealing resin 68 covers the surface and side surfaces of the circuit substrate 61 with the back surface of the circuit substrate 61 exposed. Further, leads 66 are fixed to the conducting pattern 63 to be led to the outside through the sealing resin 68.

According to the embodiment of the present invention, a switching element partially constituting a power recovery circuit can be prevented from being turned on with incorrect timing. Specifically, when the voltage of a capacitor partially constituting the power recovery circuit drops with a discharge, the voltage between the gate and source of a switching element connected to the capacitor increases. In the present embodiment, the threshold voltage of the switching element connected to the capacitor is set higher than those of other switching elements. Accordingly, the switching element is prevented from malfunctioning due to the voltage drop across the capacitor, and each switching element can be caused to operate with predetermined timing.

What is claimed is:

1. A power recovery circuit for recovering power from a capacitive load driven by a drive circuit, the power recovery circuit comprising:
a capacitor for accumulating power recovered from the capacitive load;
a first switching element for discharging the capacitor;
a second switching element for charging the capacitor; and
a level shift unit for shifting a control signal for controlling the second switching element to a voltage level of the capacitor,
wherein the second switching element maintains an OFF operation even if a voltage of the capacitor decreases due to the turning on of the first switching element.

2. The power recovery circuit according to claim 1, wherein
the second switching element is any one of a MOSFET and an IGBT, and
a current-draining electrode of the second switching element is connected to the capacitor.

3. The power recovery circuit according to claim 1, wherein a threshold voltage of the second switching element is set larger than a value of a voltage drop across the capacitor.

4. A plasma display comprising:
a drive circuit for driving a capacitive load; and
a power recovery circuit for recovering power from the capacitive load,
wherein the drive circuit comprises a first switching element for charging the capacitive load and a second switching element for discharging the capacitive load,
the power recovery circuit comprises a capacitor for accumulating power recovered from the capacitive load, a third switching element for discharging the capacitor, a fourth switching element for charging the capacitor, and a level shift unit for shifting a control signal for controlling the fourth switching element to a voltage level of the capacitor, and
the fourth switching element maintains an OFF operation even if a voltage of the capacitor decreases due to the turning on of the third switching element.

5. The plasma display according to claim 4, wherein
the fourth switching element is any one of a MOSFET and an IGBT, and
a current-draining electrode of the fourth switching element is connected to the capacitor.

6. The plasma display according to claim 4, wherein a threshold voltage of the fourth switching element is set larger than a value of a voltage drop across the capacitor.

7. A module for a plasma display, comprising a hybrid integrated circuit device fixed to a surface of a mount board, the module having a power recovery circuit incorporated therein, the power recovery circuit recovering power from a capacitive load driven by a drive circuit,
wherein the power recovery circuit comprises a capacitor for accumulating power recovered from the capacitive load, a first switching element for discharging the capacitor, a second switching element for charging the capacitor, and a level shift unit for shifting a control signal for controlling the second switching element to a voltage level of the capacitor, the second switching element maintaining an OFF operation even if a voltage of the capacitor decreases due to the turning on of the first switching element,
the first and second switching elements are incorporated in the hybrid integrated circuit device,
the capacitor is fixed directly to the mount board, and
the first and second switching elements are connected to the capacitor through conducting paths formed on the surface of the mount board.

8. The module according to claim 7, wherein a distance by which the hybrid integrated circuit device and the capacitor are separated is 1 cm to 0.5 cm.
